(19) United States
(12) Patent Application Publication
(10) Pub. No.: US 2026/0222954 A1
(43) Pub. Date: Jul. 30, 2026

(54) ENHANCED OPERATIONS DURING INTER-DONOR FULL MIGRATION

(71) Applicant: APPLE INC., Cupertino, CA (US)

(72) Inventors: Peng Cheng, Beijing (CN); Naveen Kumar R Palle Venkata, San Diego, CA (US); Fangli Xu, Beijing (CN); Zhibin Wu, Los Altos, CA (US); Yuqin Chen, Beijing (CN); Ralf Rossbach, Munich (DE); Haijing Hu, Los Gatos, CA (US); Sethuraman Gurumoorthy, San Ramon, CA (US); Alexander Sirotkin, Hod Hasharon (IL); Ping-Heng Kuo, London (GB)

(21) Appl. No.: 19/147,480

(22) PCT Filed: Feb. 16, 2023
(86) PCT No.: PCT/CN2023/076505

§ 371 Date: Jul. 11, 2025

(51) Int. Cl. H04W 36/08; H04W 4/14; H04W 24/10; H04W 36/36

(52) U.S. Cl. CPC H04W 36/087; H04W 4/14; H04W 24/10; H04W 36/362

(57) ABSTRACT

Enhanced operations during inter-donor full migration are disclosed. A network device is particularly disclosed, comprising: at least one antenna; at least one radio coupled to the at least one antenna; and a processor coupled to the at least one radio; wherein the processor is configured to: perform one or more operations related to an inter-donor full migration associated with a mobile Integrated Access and Backhaul (IAB) node.

### TECHNICAL FIELD

This disclosure relates generally to wireless communication systems, including enhanced operations during inter-donor full migration associated with a mobile Integrated Access and Backhaul (IAB) node.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY OF THE INVENTION

This disclosure is directed to enhanced operations during inter-donor full migration.

According to some embodiments, a network device is disclosed, comprising: at least one antenna; at least one radio coupled to the at least one antenna; and a processor coupled to the at least one radio; wherein the processor is configured to: perform one or more operations related to an inter-donor full migration associated with a mobile IAB node. The one or more operations may comprise one or more of: determining whether a UE is on board with respect to the mobile IAB node; avoiding the UE performing cell reselection or cell selection to a source distribute unit (DU) of the mobile IAB node; or avoiding the UE performing a RAN-based notification area update (RNAU) operation.

According to some embodiments, a UE is disclosed, comprising: at least one antenna; at least one radio coupled to the at least one antenna; and a processor coupled to the at least one radio; wherein the processor is configured to: perform one or more operations related to an inter-donor full migration associated with a mobile IAB node. The one or more operations may comprise one or more of: reporting information to a network device for determining whether the UE is on board with respect to the mobile IAB node; avoiding performing cell reselection or cell selection to a source DU of the mobile IAB node; or avoiding performing a RNAU operation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an exemplary network environment, according to embodiments disclosed herein.

FIG. 4 illustrates an exemplary network environment in which a migration of an IAB node occurs, according to embodiments disclosed herein.

FIGS. 5A-5D illustrates an exemplary network environment in which an inter-donor full migration of an IAB node occurs, according to embodiments disclosed herein.

FIG. 6 illustrates an exemplary method performed related to an inter-donor full migration of a mobile IAB node, according to embodiments disclosed herein.

FIG. 7 illustrates an exemplary network environment in which exemplary on-board UEs and off-board UEs are presented.

FIG. 8 illustrates an exemplary method for determining whether a UE is on board.

FIG. 9 illustrates an exemplary method for avoiding a UE performing cell reselection or cell selection to a source DU.

### DETAILED DESCRIPTION

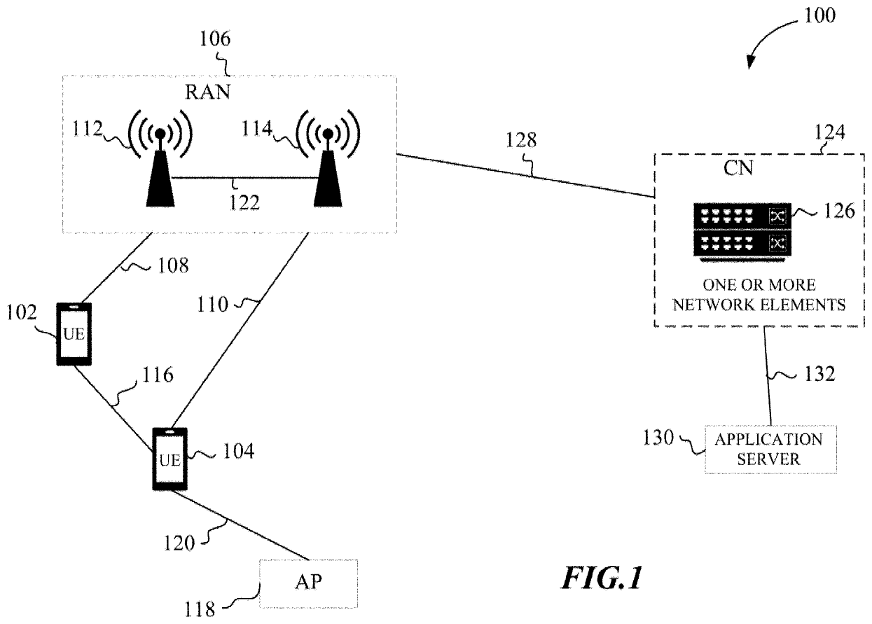

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

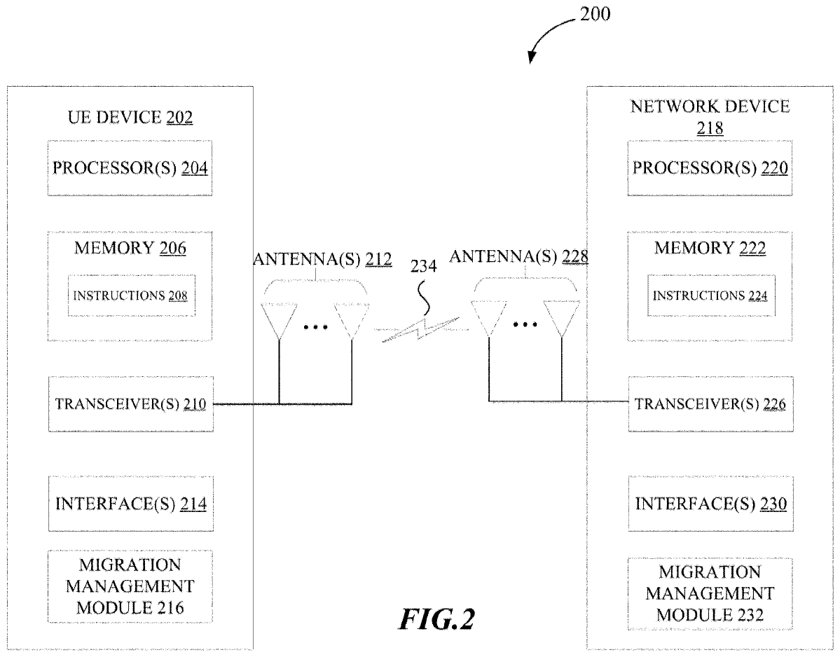

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a migration management module 216. The migration management module 216 may be implemented via hardware, software, or combinations thereof. For example, the migration management module 216 may be implemented as a processor, circuit, and/or instructions 208 stored in the memory 206 and executed by the processor(s) 204. In some examples, the migration management module 216 may be integrated within the processor(s) 204 and/or the transceiver(s) 210. For example, the migration management module 216 may be implemented by a combination of software components (e.g., executed by a DSP or a general processor) and hardware components (e.g., logic gates and circuitry) within the processor(s) 204 or the transceiver(s) 210.

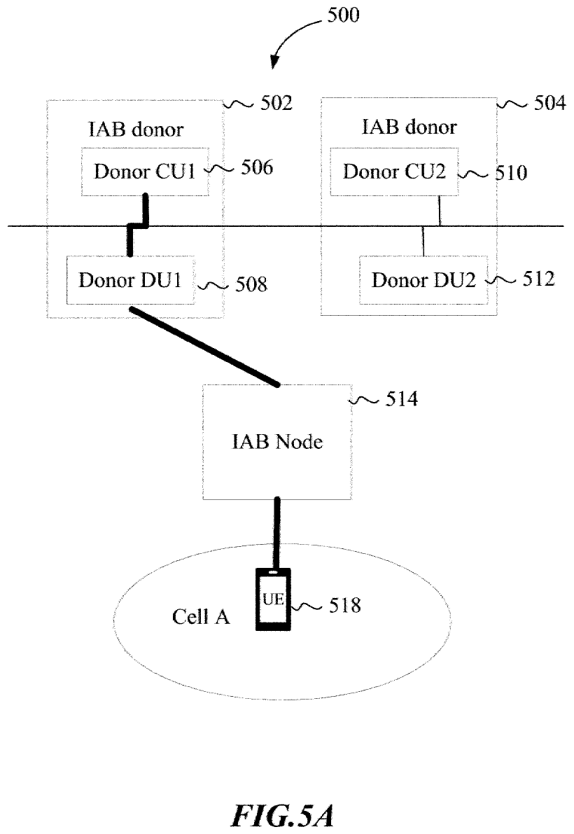

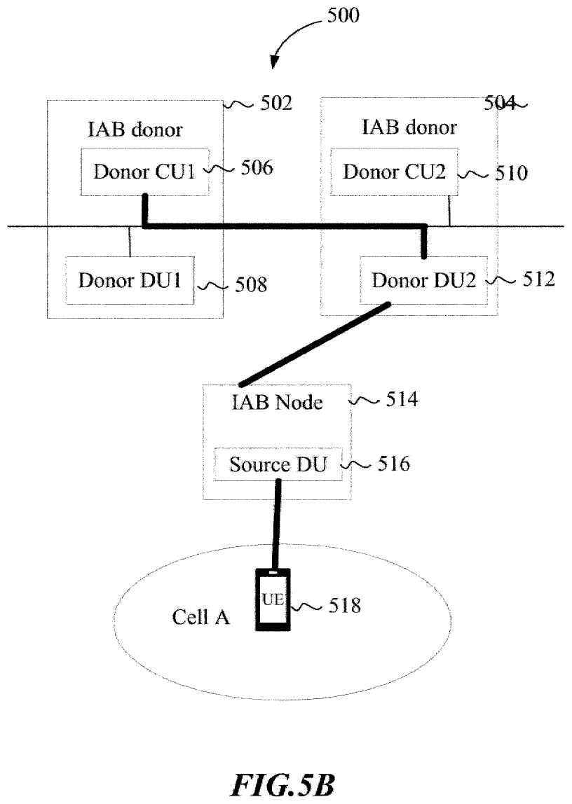

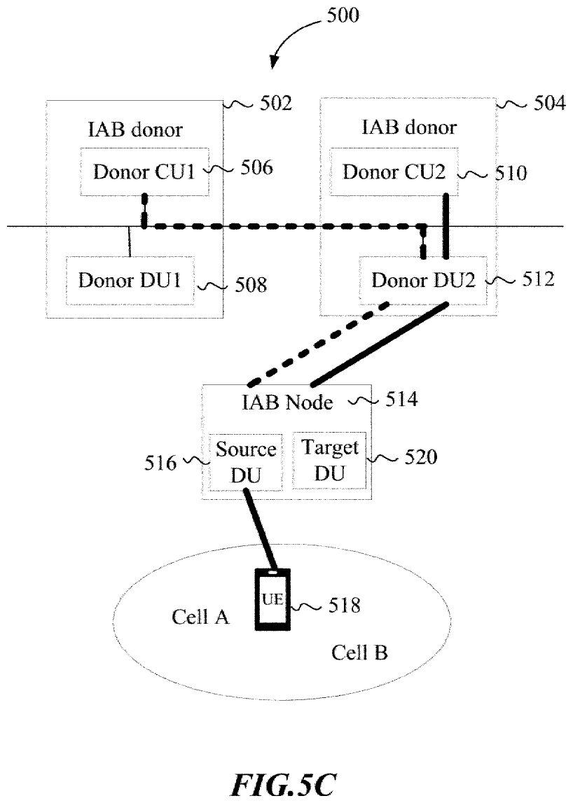

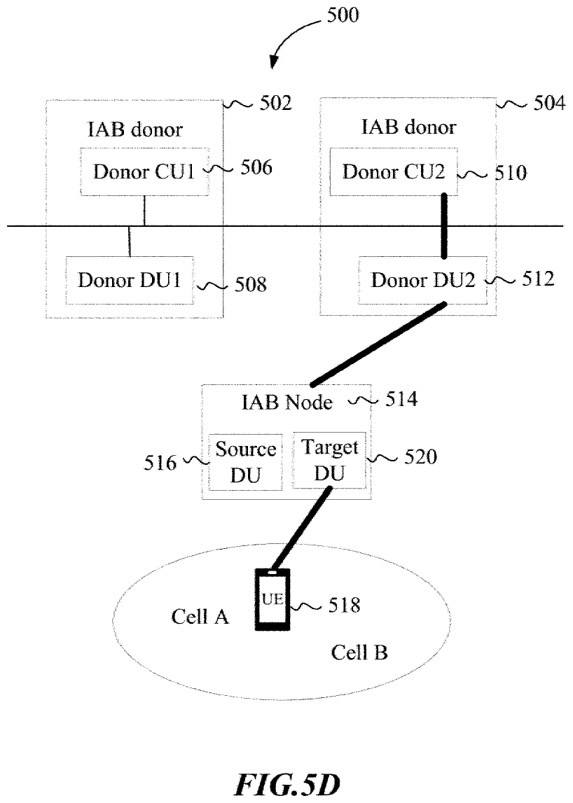

The migration management module 216 may be used for various aspects of the present disclosure, for example, aspects of FIGS. 5A-FIG. 9. The migration management module 216 is configured to perform operations associated with the inter-donor full migration process at the UE side.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include a migration management module 232. The migration management module 232 may be implemented via hardware, software, or combinations thereof. For example, the migration management module 232 may be implemented as a processor, circuit, and/or instructions 224 stored in the memory 222 and executed by the processor(s) 220. In some examples, the migration management module 232 may be integrated within the processor(s) 220 and/or the transceiver(s) 226. For example, the migration management module 232 may be implemented by a combination of software components (e.g., executed by a DSP or a general processor) and hardware components (e.g., logic gates and circuitry) within the processor(s) 220 or the transceiver(s) 226.

The migration management module 232 may be used for various aspects of the present disclosure, for example, aspects of FIGS. 5A-FIG. 9. The migration management module 232 is configured to perform operations associated with the inter-donor full migration process at the network side.

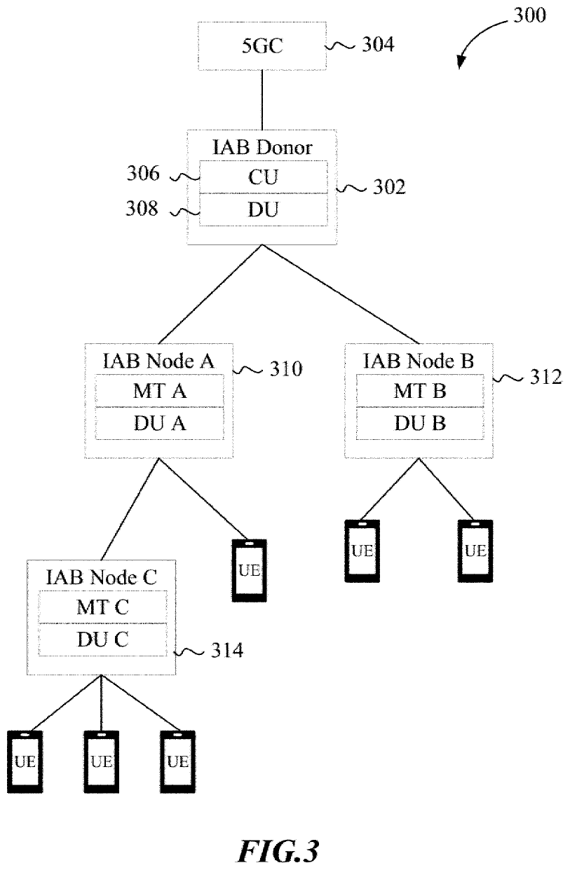

FIG. 3 illustrates an exemplary network environment 300, according to embodiments disclosed herein. The network environment 300 may include an IAB architecture that includes a number of RAN nodes. The RAN nodes together are configured to provide network access to various UEs.

In some embodiments, the RAN nodes of the network environment 300 may include an IAB donor 302. The IAB donor 302 may be coupled with a 3GPP Fifth Generation Core Network (5GC) 304. For example, the IAB donor 302 may be coupled with the 5GC 304 via a fiber backhaul.

In some embodiments, the IAB donor 302 may include a centralized unit (CU) 306 and one or more distributed units (DUs) 308. The CU 306 may be configured to handle higher-layer protocols for the IAB donor 302, for example, radio resource control (RRC), packet data convergence (PDCP), and service data adaptation protocol (SDAP) layer protocols. The DUs 308 may be configured to handle lower-layer protocols for IAB donor 302, for example, radio link control (RLC), media access control (MAC), and physical (PHY) layer protocols.

In some embodiments, the IAB donor 302 may provide a wireless backhaul to one or more IAB nodes in the network environment 300, such as an IAB node A 310, an IAB node B 312, and an IAB node C 314. Some of the IAB nodes (for example, the IAB node A 310 and the IAB node B 312) may be coupled directly with the IAB donor 302 (more specifically, with the DU 308 of the IAB donor 302). Some of the IAB nodes (for example, the IAB node C 314) may be coupled indirectly with the IAB donor 302 over one or more hops through other IAB nodes (for example, the IAB node A 310). The IAB node A 310 may be referred as a parent IAB node for the IAB node C 314, which may provide a wireless backhaul for the IAB node C 314.

In some embodiments, each of the IAB nodes may include a mobile termination (MT) and a DU. A MT of an IAB node may be used to connect the IAB node with an upstream (for example, towards the 5GC 304) RAN node, such as the parent IAB node of the IAB node or the IAB donor 302. The MT may provide the IAB node with access functionality similar to a UE, such that the IAB node may appear like a UE to the upstream RAN node. A DU of the IAB node may be used to connect the IAB node with one or more downstream entities, such as one or more descendent IAB nodes or one or more UEs. The DU may establish an RLC channel to the UEs or to the MTs of the downstream IAB nodes. In the embodiment shown in FIG. 3, the DU A of the IAB node A 310 may connect to the downstream IAB node C 314 and one or more UEs, the DU B of the IAB node B 312 may connect to one or more UEs, and the DU C of the IAB node C 314 may connect to one or more UEs. Each of the UEs may be served by a respective series of IAB nodes (to which it is connected), the IAB donor 302 and eventually the 5GC 304. For example, a UE that is connected to the IAB node C 314 may be served by the IAB node C 314, the IAB node A 310, the IAB donor 302 and eventually the 5GC 304. Another UE that is connected to the IAB node B 312 may be served by the IAB node B 312, the IAB donor 302 and eventually the 5GC 304.

Although FIG. 3 shows a specific example of the network environment 300, it is readily understood that the arrangement of IAB nodes is not limited to this example. The number and the hierarchy of the IAB nodes may vary from one implementation to another. For example, although network environment 300 is shown with three IAB nodes A, B and C, the network environment 300 in other embodiments may include fewer or more IAB nodes. In further embodiments, the IAB nodes may be arranged into more than two levels. Also, although FIG. 3 illustrates that network environment 300 includes a single IAB donor 302 with a single CU 306, network environment 300 in other embodiments may include more IAB donors, such that one or more IAB nodes may migrate from one donor to another donor, which will be discussed in more details below.

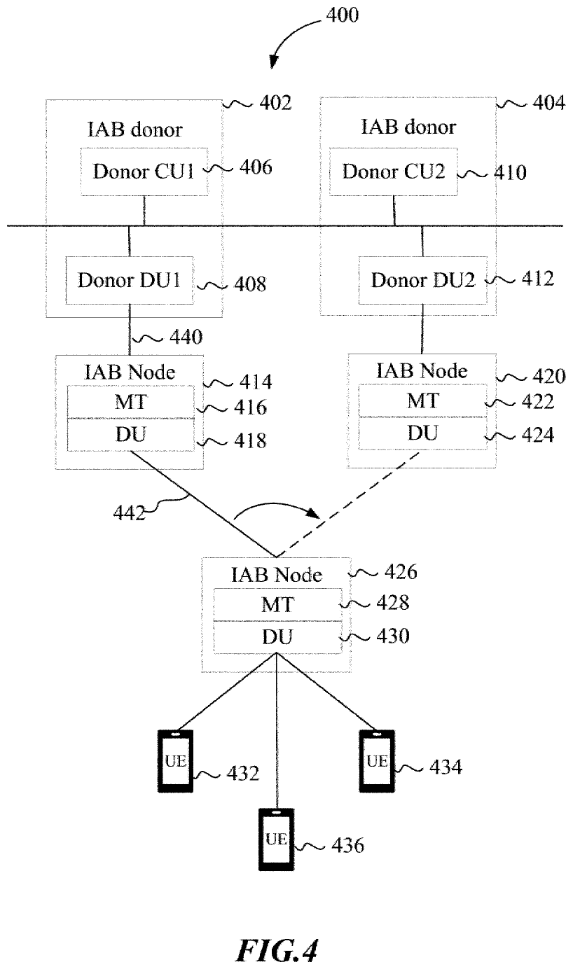

FIG. 4 illustrates an exemplary network environment 400 in which a migration of an IAB node occurs, according to embodiments disclosed herein.

In some embodiments, the network environment 400 may include two IAB donors 402 and 404. Each of the IAB donors 402 and 404 may be mounted at a respective fixed position in a cell they are serving. In some embodiments, the IAB donors 402 and 404 may be connected with each other via one or more connections. In some embodiments, the one or more connections may include one or more wired connections, such that the IAB donors 402 and 404 may reliably communicate with each other.

In some embodiments, each of the IAB donors 402 and 404 may be connected to one or more respective downstream IAB nodes. For example, the IAB donor 402 may be connected to the IAB node 414, and the IAB donor 404 may be connected to the IAB node 420. More specifically, the donor DU 408 of the IAB donor 402 may be connected to the MT 416 of IAB node 414, and the donor DU 412 of the IAB donor 404 may be connected to the MT 422 of the IAB node 420. Although FIG. 4 shows each of the IAB donors 402 and 404 is connected to one descendent IAB node, it is readily understood that the IAB donors 402 and 404 in other embodiments may be connected to more descendent IAB nodes.

In some embodiments, the network environment 400 may further include one or more IAB nodes, such as IAB node 426. In some embodiments, the IAB node 426 may be a mobile IAB node that is able to move in the network environment 400. For example, the IAB node 426 may not be mounted at a fixed position. Instead, the IAB node 426 may be configured to be a movable device in the cell. Mobility of the mobile IAB node 426 may provide flexibility enhancement for the network environment 400.

In some embodiments, mobility of the IAB node 426 may allow the IAB node 426 to migrate from a source IAB donor to a target IAB donor, which is referred as inter-donor migration herein. For example, the IAB node 426 may be initially connected with the IAB donor 402 via the intermediate IAB node 414. At some point, the IAB node 426 may migrate from the IAB donor 402 to the IAB donor 404. Migration of the mobile IAB node 426 may be triggered by various factors, including but not limited to a radio link failure (RLF) associated with the IAB node 426 or one of its parent IAB nodes or a handover (HO) process associated with the IAB node 426.

In some embodiments, the inter-donor migration may include inter-donor partial migration. Under inter-donor partial migration, the MT of the migrating IAB node may migrate from a parent IAB node underneath a CU of a source IAB donor to a parent IAB node underneath a CU of a target IAB donor, while the collocated DU(s) of the migrating IAB node and its descendant IAB node(s) retain F1 connectivity with the CU of the source IAB donor. For example, if the IAB node 426 performs an inter-donor partial migration between the source IAB donor 402 and the target IAB donor 404, the MT 428 of the migrating IAB node 426 will migrate from the source parent IAB node 414 to the target parent IAB node 420, while the DU 430 of the migrating IAB node 426 remains F1 connectivity with the CU 406 of the source IAB donor 402. If the migrating IAB node 426 has one or more descendant IAB nodes, the DUs of those descendant IAB nodes will also remain F1 connectivity with the CU 406 of the source IAB donor 402. After the inter-donor partial migration, F1 traffic of the DU 430 of the migrating IAB node 426 and its descendant IAB node(s) will be routed via a BAP layer of the topology to which the MT 428 of the migrating IAB node 426 has migrated. Due to the inter-donor partial migration, the DU 430 of the migrating IAB node 426 does not change after migration (e.g., still being served by donor CU1 406 of the IAB donor 402). As such, its descendant IAB node(s) and associated UEs do not need to perform a migration process or a handover process.

In other embodiments, the inter-donor migration may include inter-donor full migration. The inter-donor full migration may cause both of the MT and the DU of a migrating IAB node and its descendant IAB nodes to migrate from a parent IAB node underneath a CU of a source IAB donor to a parent IAB node underneath a CU of a target IAB donor. The collocated DU(s) of the migrating IAB node and its descendant IAB node(s) will not retain F1 connectivity with the CU of the source IAB donor, which is different from the inter-donor partial migration. In general, a first stage of the inter-donor full migration may be same as the inter-donor partial migration. In a second stage after that, the DU of the migrating IAB node may additionally switch to a new donor CU, instead of remaining connectivity with the old donor CU. During this stage, UEs moving with such DU will perform a handover process to also switch from the old donor CU to the new donor CU.

FIGS. 5A-5D illustrates an exemplary network environment 500 in which an inter-donor full migration of an IAB node occurs, according to embodiments disclosed herein. In network environment 500, a mobile IAB node 514 is migrating from a source IAB donor 502 to a target IAB donor 504. The mobile IAB node 514 is therefore referred to as a migrating IAB node. For the purpose of clarity, the network environment 500 is simplified as compared to the network environment 400. Specifically, the migrating IAB node 514 is shown to directly connect to the source IAB donor 502 (and also, after migration, to the target IAB donor 504), with no intermediate IAB nodes. Also, only one UE 518 is shown for clarity. It is readily understood that this embodiment is merely for illustration, not for limitation. The same principles may apply to other embodiments, for example, those providing a plurality of UEs and/or intermediate IAB nodes between the migrating IAB node and IAB donors.

As shown in FIG. 5A, a UE 518 associated with the migrating IAB node 514 may be initially connected to the source IAB donor via a communication path shown as a bold line. The IAB node 514 is connected to donor DU1 508 of the IAB donor 502. The donor DU1 508 is connected to the donor CU1 of the IAB donor 502.

When the inter-donor full migration of IAB node 514 begins, a source DU 516 that may be implemented in the migrating IAB node 514 may connect to the donor DU2 512 of the IAB donor 504. Meanwhile, the source DU 516 may remain connectivity with the donor CU1 of the IAB donor 502. The UE 518 connects to the source DU 516 of the IAB node 514. The communication path between the UE 518 and its serving donor CU (i.e., donor CU1 506) is shown with as a bold line.

After that, the migrating IAB node 514 may proceed to perform migration from the old donor CU1 506 to a new donor CU2 510. To do this, the migrating IAB node 514 may establish a new DU 520 as a target DU. The target DU 520 may connect to donor CU2 510 of the IAB donor 504 via the donor DU2 512, as is shown with the bold line in FIG. 5C. The target DU 520 may be logically different from the source DU 516, although both DUs may be implemented by the IAB node 514. For example, the target DU 520 may be associated with a new Cell B, which, in the perspective of UEs, may be a different physical cell from Cell A that is associated with the source DU 516. For example, Cell B may be allocated with a different physical cell identifier (PCI) or cell ID than that of Cell A (even if a same carrier is adopted for both cells). Additionally, these two separate logical DU cells (e.g., Cell A and Cell B) may use separate physical resources, such as different carriers, or orthogonal time and frequency resource of a same carrier. In FIG. 5C, the former communication path association with source DU 516 is shown with dotted bold line.

In the step shown in FIG. 5D, the source DU 516 may be released by the IAB node 514 after the migration, because it is not useful anymore. The target DU 520, which connects to the new donor CU2 510, may serve as the active DU of the migrating IAB node 514. For the UE 518, a handover process from Cell A to Cell B may be performed such that the UE 518 may switch from the source DU 516 to the target DU 520.

During the inter-donor full migration of the IAB node, one or more enhancements may be desired. For example, it may be desired to determine a type of a UE (e.g., on-board UE or off-board) and adopt different operations based on the type of the UE. Additionally, during cell selection or reselection, it may be desired to prevent the UE from selecting the source DU (to be released) of the mobile IAB node. Also, certain conventional operations in an ordinary handover process may be omitted during the inter-donor full migration of the IAB node.

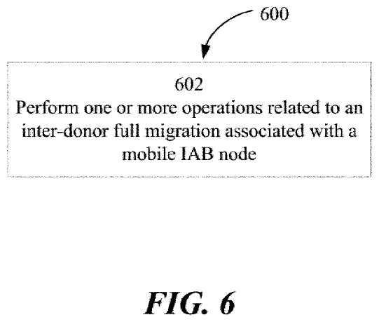

FIG. 6 illustrates an exemplary method 600 performed related to an inter-donor full migration of a mobile IAB node, according to embodiments disclosed herein.

Method 600 may include a step 602 of performing one or more operations related to an inter-donor full migration associated with the mobile IAB node. In some embodiments, the method 600 may be performed by a network device associated with the mobile IAB node. In this case, the one or more operations may include one or more of: determining whether a UE is on board with respect to the mobile IAB node; avoiding the UE performing cell reselection or cell selection to a source DU of the mobile IAB node; or avoiding the UE performing a RNAU operation In other embodiments, the method 600 may be performed by a UE associated with the mobile IAB node. In this case, the one or more operations may include one or more of: reporting information to a network device for determining whether the UE is on board with respect to the mobile IAB node; avoiding performing cell reselection or cell selection to a source DU of the mobile IAB node; or avoiding performing a RNAU operation. The one or more operations may comprise one or more aspects discussed below in more details.

According to some embodiments disclosed herein, the one or more operations may comprise determining whether a UE is on board with respect to the mobile IAB node. A UE may be deemed as on board with respect to a mobile IAB node, if mobility of the UE is similar to that of the mobile IAB node. In other words, an on-board UE may generally move along with the mobile IAB. For example, if the UE and the mobile IAB node are both on a same vehicle, the UE and the mobile IAB node may present similar mobility. As such, the UE may be determined as on board with the mobile IAB node. Otherwise, if mobility of a UE differs from that of the mobile IAB node to a certain degree, that UE may be deemed as not on board (or, off-board) with respect to the mobile IAB node.

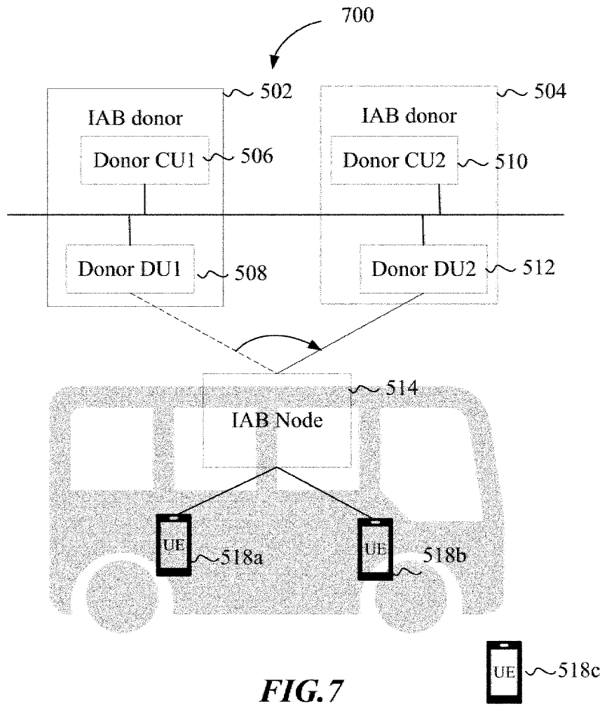

FIG. 7 illustrates an exemplary network environment 700 in which exemplary on-board UEs and off-board UEs are presented. In the network environment 700, the mobile IAB node 514 may be implemented on a bus and thus move along with the bus. In this scenario, UEs 518a and 518b, which are also on the same bus, might have a same mobility as the mobile IAB node 514. Therefore, the UE 518a and UE 518b may be deemed as on board with respect to the mobile IAB node 514. In contrast, UE 518c may be held by a user off the bus and does not have a similar mobility as the mobile IAB node 514. As such, the UE 518c may be deemed as an off-board UE with respect to the mobile IAB node 514 (even if the UE 518c may temporarily connect to the mobile IAB node 514, for example, when the bus temporarily parks nearby the UE 518c). It is understood that the network environment 700 is merely exemplary. There are other scenarios where the UEs may be divided into on-board UEs and off-board UEs with respect to a certain mobile IAB node.

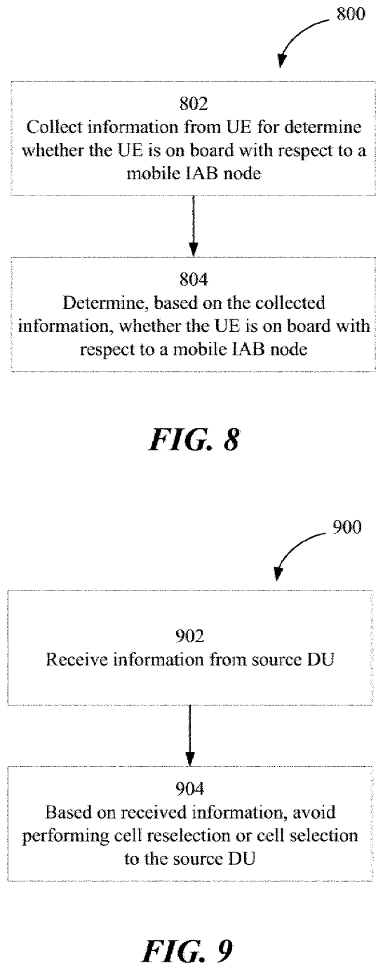

FIG. 8 illustrates an exemplary method 800 for determining whether a UE is on board. The method 800 may be performed by a network device. Although method 800 is described on the network device side, those skilled in the art would readily understand a corresponding method that may be performed on the UE side.

The method 800 may begin with step 802, where the network device is configured to collect information from a UE for determine whether the UE is on board with respect to a mobile IAB node. After that, the method 800 may proceed to step 804, where the network device is configured to determine, based on the collected information, whether the UE is on board with respect to a mobile IAB node.

According to embodiments disclosed herein, the network device may collect various types of information for determining whether the UE is on board. In some embodiments, the collected information may be a status report associated with the on-board status of the UE. Specifically, the UE may be configured to transmit, to the network device, the status report associated with an on-board status of the UE that indicates whether the UE is on board with respect to the mobile IAB node. In alternative embodiments, the collected information may be a moving speed and orientation of the UE, which may be used to determine the mobility of the UE with respect to the mobile IAB node. In yet other embodiment, other types of information that may be used to determine the mobility of the UE may be collected, without limitation.

The UE may be configured to transmit the information in various ways. Preferably, the information may be transmitted via an RRC message. Other types of signaling is also available without limitation.

The transmission of the information may be triggered in response to various events. In the embodiments where the information contains a status report of the UE, the status report may be transmitted by the UE in response to a request from the network device (e.g., gNB).

Alternatively or additionally, the status report may be transmitted by the UE in response to a status change of the on-board status of the UE. Specifically, when the UE enters the on-board status, the UE may transmit the status report to indicate that it is now on board. Also, when the UE leaves the on-board status, the UE may transmit the status report to indicate it is now off board.

Alternatively or additionally, the UE may periodically transmit its status report to the network device. For example, the UE may transmit its status report (on-board or off-board) in response to expiration of a configured timer associated with the UE. In some instances, the configured timer may be periodic. The periodic timer may be configured by the network device for the UE.

Alternatively or additionally, the status report may be transmitted by the UE in response to a determination that the UE has camped on a cell associated with the mobile IAB node for a configured time period. In this case, if the UE has camped on the cell for a sufficient time period, the UE may consider itself as on board with respect to the mobile IAB node. This is applicable to all types of UEs, but specifically preferred for UEs in the IDLE state or the INACTIVE state. Accordingly, the UE may transmit its status report to the network device. The configured time period may be specified by the network device. In some instances, a particular timer may be implemented on the UE for determining expiration of the configured time period.

In alternative embodiments where the transmitted information contains a moving speed and orientation of the UE, the transmission of the moving speed and orientation may be triggered in response to various events.

In some embodiments, the moving speed and orientation may be transmitted by the UE in response to a request from the network device (e.g., gNB).

Alternatively or additionally, the UE may periodically transmit its moving speed and orientation to the network device. For example, the UE may transmit its moving speed and orientation in response to expiration of a configured periodic timer associated with the UE. The periodic timer may be configured by the network device for the UE.

Alternatively or additionally, the UE may conditionally transmit its moving speed and orientation to the network device. For example, the moving speed and orientation may be transmitted by the UE in response to a determination that the moving speed and orientation of the UE has met one or more configured conditions. In some instances, the one or more configured conditions may specify a speed threshold and/or a moving angle range. If the moving speed of the UE is not within the specified speed threshold, and/or if the moving orientation is not within the specified angle range, the UE may be triggered to report its moving speed and orientation to the network device. Other configured conditions may also be applicable without limitation. The one or more configured conditions may be specified by the network device for the UE.

According to embodiments disclosed herein, the network device may determine, based on the collected information, whether the UE is on board with respect to the mobile IAB node. In the embodiments where the collected information contains the status report of the UE, the network device may extract the status of the UE directly from the received status report. In the embodiments where the collected information contains the moving speed and orientation of the UE, the network device may determine, based on the moving speed and orientation, whether the UE is on board with respect to the mobile IAB. For example, the network device may determine the UE is on board if the moving speed and orientation of the UE are substantially consistent with those of the mobile IAB node. Other techniques may also be applicable without limitation.

According to embodiments disclosed herein, the network device may perform one or more actions based on a result of determining whether the UE is on board. Different operations may be performed for a determined on-board UE or a determined off-board UE. For example, in response to a determination that the UE is on board with respect to the mobile IAB node, the network device may configure the UE to perform a conditional handover (CHO) process or a RACH-less handover process during the inter-donor full migration. Otherwise, in response to a determination that the UE is not on board with respect to the mobile IAB node, the network device may not configure the UE to perform the conditional handover process or the RACH-less handover process during the inter-donor full migration.

According to alternative or additional embodiments disclosed herein, the one or more operations related to the inter-donor full migration, performed in step 602 of method 600, may further include avoiding one or more UEs performing cell reselection or cell selection to the source DU that will be released after the inter-donor full migration. As discussed in FIG. 5D, the source DU of the mobile IAB node will be released after the inter-donor full migration is completed. According to embodiments disclosed herein, UEs in the IDLE/INACTIVE state are prevented from performing cell reselection (for example, for RRC establishment or resume) to the source DU. Also, UEs in the CONNECTED state are prevented from performing cell selection (for example, for RRC re-establishment) to the source DU.

FIG. 9 illustrates an exemplary method 900 for avoiding a UE performing cell reselection or cell selection to a source DU. The method 900 may be performed by the UE. Although method 900 is described on the UE side, those skilled in the art would readily understand a corresponding method that may be performed on the network device side.

The method 900 may begin with step 902, where the UE is configured to receive information from a source DU. After that, the method 900 may proceed to step 904, where the UE is configured to avoid, based on received information, performing cell reselection or cell selection to the source DU.

According to embodiments disclosed herein, the information received in step 902 may be an indication that is transmitted by the source DU. The indication may be transmitted after the source DU has transmitted a handover (HO) command or a conditional handover (CHO) command during the inter-donor full migration. The indication may be used to indicate that a cell (e.g., Cell A in the example of FIGS. 5A-5D) associated with the source DU (e.g., source DU 516 in the example of FIGS. 5A-5D) is not available for cell selection or re-selection. The indication may be implemented in various forms.

In one embodiment, the indication may be implemented as a barring bit in a master information block (MIB) associated with the source DU. In this case, after the source DU has successfully transmitted the HO command or the CHO command, the source DU may set its barring bit in the MIB, thereby denying all its camping UEs and coming IDLE UEs or INACTIVE UEs. The barring bit may be, for example, a cellBarred field in the MIB. Upon receiving such a set barring bit in the MIB associated with the source DU, the UEs may not choose the cell associated with the source DU for cell selection or reselection.

In an alternative embodiment, the indication may be implemented as a reservation bit in a system information block (SIB) associated with the source DU. In this case, after the source DU has successfully transmitted the HO command or the CHO command, the source DU may set one reservation bit in the SIB, thereby denying its camping UEs and coming IDLE UEs or INACTIVE UEs. The reservation bit may be, for example, a cellReservationForOtherUse field or a cellReservationForFutureUse field in the SIB. Upon receiving such a set reservation bit in the SIB associated with the source DU, the UEs may not choose the cell associated with the source DU for cell selection or reselection.

According to alternative embodiments disclosed herein, the information received in step 902 may be a notification of execution of the inter-donor full migration. Specifically, the source DU may first notify the UEs of execution of the inter-donor full migration. Given that some of the UEs may be in the IDLE or INACTIVE state, the notification of execution of the inter-donor full migration may be transmitted via paging, short message or group common downlink control information (e.g., extended DCI 2-7). Upon receiving the notification, the UE may perform one or more actions to avoid cell selection or reselection to the source DU. In one example, the UE may regard the source DU as a candidate cell with a relatively low (for example, the lowest) priority during cell reselection or cell selection. As such, the source DU is very unlikely to be chosen during cell reselection or cell selection. In another example, the UE may suspend mobility operation until mitigation of a MT and a DU of the mobile IAB has completed. Other actions are also applicable. The one or more actions may be performed until the full migration is completed (for example, a change of PCI/cell ID of the serving cell has been detected).

Instead of explicitly transmitting information to the UEs at step 902, according to alternative embodiments disclosed herein, the source DU may perform one or more adjustments to itself so as to force the UEs to leave/avoid the source DU. For example, after the source DU has successfully transmitted the HO command or the CHO command, the source DU may decrease its transmit power to a certain low level. Upon detection of a decreased transmit power associated with the source DU, all its camping UEs may automatically leave the source DU while coming IDLE/INACTIVE UEs will not choose the source DU to camp.

According to alternative or additional embodiments disclosed herein, the one or more operations related to the inter-donor full migration, performed in step 602 of method 600, may further include avoiding a UE performing a RAN-based notification area update (RNAU) operation after inter-donor full migration.

In some scenarios, the RNAU operation after the migration may be unnecessary. In the inter-donor full migration, it is possible the source CU and the target CU are in a same RNA area. This makes a RNAU operation unnecessary. Conventionally, a cell ID list is used for RNA area configuration. The target CU may use a new cell ID that is not known by the UE, which is possibly to trigger an unnecessary RNAU operation. In other scenarios, the RNAU operation after the migration may cause RACH collision. For example, if the target CU and the source CU are in different RNA areas, simultaneous group RNAU may occur and cause RACH collisions. It is desired to avoid these RNAU operations for the inter-donor full migration.

According to the present disclosure, various embodiments may be implemented to provide enhancements related to the RNAU operations during the inter-donor full migration.

According to some embodiments disclosed herein, a reserved list of cell IDs may be used to indicate the RNAU operation may be omitted. Specifically, in case of inter-donor full migration, the network device may configure the target CU to allocate a particular cell ID to a target DU of the mobile IAB node, with the particular cell ID being selected only from the reserved list. Each cell ID in the reserved list may be preconfigured to not trigger a RNAU operation. The reserved list may be preconfigured and known to both the UE and the network device. For example, the reserved list may be preconfigured in UE's subscription or be configured when UE is in CONNECTED state. During the inter-donor full migration (for example, the handover or conditional handover process), the UE may receive a particular cell ID that is allocated to the target DU of the mobile IAB mode. The UE may determine whether the particular cell ID is within the reserved list. In response to a determination that the particular cell ID is within the reserved list, the UE may determine not to trigger a RNAU operation, irrespective whether the particular cell ID is within a current RNA cell list.

According to some embodiments disclosed herein, the source CU may perform group UE context relocation on behalf of UEs (e.g., INACTIVE UEs). A source CU of the mobile IAB node may implement the source DU and the target DU during the inter-donor full migration. Stored UE context of each UE may be forwarded to the target CU. Specifically, in case of inter-donor full migration, the source CU may forward, on behalf of the UEs, all UE context of its INACTIVE UEs to the target CU via signaling between network devices (e.g., gNB signaling). In this scenario, several methods may be implemented to avoid trigger of RNAU operations after migration, thereby avoiding RACH collisions as described above.

In one embodiment, the UE may determine to suspend its RNAU operation based on the status of the UE. Specifically, the UE may determine whether the UE is on board with respect to the mobile IAB mode. In response to a determination that the UE is on board with respect to the mobile IAB mode, the UE may determine not to trigger a RNAU operation after migration.

In another optional embodiment, the target DU may be configured to notify the UE not to trigger the RNAU operation. In response to receiving the notification, the UE may determine not to trigger the RNAU operation. In some instance, the notification may be transmitted via paging, short message or group common downlink control information (e.g., extended DCI 2-7).

In yet another optional embodiment, a reserved list of PCI/cell ID may be used to avoid RNAU operations, as described above.

According to some embodiments disclosed herein, a new RAN area information element (IE) may be introduced for addressing the RNAU issues. This may be specifically applicable to a scenario where an INACTIVE UE is able to determine whether that UE is on board or not. It may be assumed that the RNA area of a determined on-board INACTIVE UE is same as its connected mobile IAB node that is moving together. In this case, the network device may transmit a RAN area IE in a SIB associated with the target DU of the mobile IAB node. The RAN area IE in the SIB may be same as RAN area configuration stored by the target DU of the mobile IAB node. The UE may be configured to receive the RAN area IE in the SIB associated with the target DU. The UE may also determine whether the UE is on board with respect to the mobile IAB mode. In response to a determination that the UE is on board with respect to the mobile IAB mode, the UE may update a stored RNA area configuration of the UE based on the received RAN area IE and without a RNAU operation. Specifically, the on-board UE may first read the RAN area IE that is associated with the target cell after camping, The UE may then replace the old one in its stored RNA area configuration with the new one read from the RAN area IE. This procedure does not require a conventional RNAU operation. In this manner, both unnecessary RNAU operations and RNAU operations that may cause RACH collisions may be resolved.

Embodiments contemplated herein include an apparatus comprising means to perform one or more elements of the methods 600, 800 and/or 900 described herein. This apparatus may be, for example, an apparatus of a UE (such as a wireless device 202 that is a UE, as described herein), or an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of methods 600, 800 and/or 900. This non-transitory computer-readable media may be, for example, a memory of a UE (such as a memory 206 of a wireless device 202 that is a UE, as described herein), or a memory of a base station (such as a network device 218 that is a base station, as described herein).

Embodiments contemplated herein include an apparatus comprising logic, modules, or circuitry to perform one or more elements of methods 600, 800 and/or 900. This apparatus may be, for example, an apparatus of a UE (such as a wireless device 202 that is a UE, as described herein) or an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of methods 600, 800 and/or 900. This apparatus may be, for example, an apparatus of a UE (such as a wireless device 202 that is a UE, as described herein) or an apparatus of a base station (such as a network device 218 that is a base station, as described herein).

Embodiments contemplated herein include a signal as described in or related to one or more elements of methods 600, 800 and/or 900.

Embodiments contemplated herein include a computer program or computer program product comprising instructions, wherein execution of the program by a processor is to cause the processor to carry out one or more elements of methods 600, 800 and/or 900. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein) or a memory of a base station (such as a network device 218 that is a base station, as described herein).

At least the following embodiments are disclosed herein.

According to embodiments disclosed herein, a network device is disclosed, comprising: at least one antenna; at least one radio coupled to the at least one antenna; and a processor coupled to the at least one radio; wherein the processor is configured to: perform one or more operations related to an inter-donor full migration associated with a mobile Integrated Access and Backhaul (IAB) node, wherein the one or more operations comprise one or more of: determining whether a user equipment (UE) is on board with respect to the mobile IAB node; avoiding the UE performing cell reselection or cell selection to a source distribute unit (DU) of the mobile IAB node; or avoiding the UE performing a RAN-based notification area update (RNAU) operation.

In some of the embodiments, the processor is configured to determine whether the UE is on board with respect to the mobile IAB node at least by: receiving, from the UE, a status report associated with an on-board status of the UE.

In some of the embodiments, the status report is received in response to at least one of: a request transmitted from the network device to the UE; a status change of an on-board status of the UE; expiration of a configured periodic timer associated with the UE; and/or a determination that the UE has camped on a cell associated with the mobile IAB node for a configured time period.

In some of the embodiments, the processor is configured to determine whether the UE is on board with respect to the mobile IAB node at least by: receiving a moving speed and orientation of the UE; and determining, at least based on the received moving speed and orientation of the UE, whether the UE is on board with respect to the mobile IAB node.

In some of the embodiments, the moving speed and orientation of the UE is received in response to at least one of: a request transmitted from the network device to the UE; expiration of a configured periodic timer associated with the UE; and/or a determination that the moving speed and orientation of the UE has met one or more configured conditions.

In some of the embodiments, the processor is further configured to: in response to a determination that the UE is on board with respect to the mobile IAB node, configure the UE to perform a conditional handover process or a RACH-less handover process during the inter-donor full migration; and in response to a determination that the UE is not on board with respect to the mobile IAB node, not configure the UE to perform the conditional handover process or the RACH-less handover process during the inter-donor full migration.

In some of the embodiments, the processor is configured to avoid the UE performing cell reselection or cell selection to the source DU at least by one of: setting a barring bit in a master information block (MIB) associated with the source DU to deny camping UE and coming IDLE UEs or INACTIVE UEs; setting a reservation bit in a system information block (SIB) associated with the source DU to deny camping UE and coming IDLE UEs or INACTIVE UEs; and/or decreasing a transmit power associated with the source DU.

In some of the embodiments, the processor is configured to avoid the UE performing cell reselection or cell selection to the source DU at least by: the source DU notifying the UE of execution of the inter-donor full migration through one of paging, short message or group downlink control information (DCI).

In some of the embodiments, the processor is configured to avoid the UE performing the RNAU operation at least by: allocating a particular cell ID to a target DU of the mobile IAB node, wherein the particular cell ID is selected from a reserved list, and wherein each cell ID in the reserved list is preconfigured to not trigger the RNAU operation.

In some of the embodiments, the processor is configured to avoid the UE performing the RNAU operation at least by: configuring a target DU of the mobile IAB node to notify the UE not to trigger the RNAU operation.

In some of the embodiments, a source centralized unit (CU) of the mobile IAB node implements the source DU and the target DU during the inter-donor full migration, and wherein the one or more operations comprise at least: forwarding stored UE context of each UE to the target CU.

In some of the embodiments, the processor is configured to avoid the UE performing the RNAU operation at least by: transmitting a RAN area information element in a system information block (SIB) associated with a target DU of the mobile IAB node, wherein the RAN area information element is used by the UE to update a stored RNA area configuration of the UE without the RNAU operation.

In some of the embodiments, the RAN area information element in the SIB is same as RAN area configuration stored by the target DU of the mobile IAB node.

According to embodiments disclosed herein, A UE is disclosed, comprising: at least one antenna; at least one radio coupled to the at least one antenna; and a processor coupled to the at least one radio; wherein the processor is configured to: perform one or more operations related to an inter-donor full migration associated with a mobile Integrated Access and Backhaul (IAB) node, wherein the one or more operations comprise one or more of: reporting information to a network device for determining whether the UE is on board with respect to the mobile IAB node; avoiding performing cell reselection or cell selection to a source distribute unit (DU) of the mobile IAB node; or avoiding performing a RAN-based notification area update (RNAU) operation.

In some of the embodiments, the processor is configured to reporting the information at least by: transmitting, to a network device, a status report associated with an on-board status of the UE that indicates whether the UE is on-board with respect to the mobile IAB node.

In some of the embodiments, the status report is transmitted in response to at least one of: a request transmitted from the network device to the UE; a status change of the on-board status of the UE; expiration of a configured periodic timer associated with the UE; and/or a determination that the UE has camped on a cell associated with the mobile IAB node for a configured time period.

In some of the embodiments, the processor is configured to reporting the information at least by: transmitting, to a network device, a moving speed and orientation of the UE, for determining whether the UE is on-board with respect to the mobile IAB node.

In some of the embodiments, the moving speed and orientation of the UE is transmitted in response to at least one of: a request transmitted from the network device to the UE; expiration of a configured periodic timer associated with the UE; and/or a determination that the moving speed and orientation of the UE has met one or more configured conditions.

In some of the embodiments, the processor is configured to avoid cell reselection or cell selection to the source DU based on at least one of: receiving a set barring bit in a master information block (MIB) associated with the source DU; receiving a set reservation bit in a system information block (SIB) associated with the source DU; and/or detecting a decreased transmit power associated with the source DU.

In some of the embodiments, the processor is configured to avoid cell reselection or cell selection to the source DU at least by: receiving, from the source DU, a notification of execution of the inter-donor full migration; upon receiving the notification, performing at least one of: regarding the source DU as a candidate cell with the lowest priority during cell reselection or cell selection; or suspending mobility operation until mitigation of a mobile termination (MT) and a DU of the mobile IAB has completed.

In some of the embodiments, the processor is configured to avoid performing the RNAU operation at least by: receiving a particular cell ID that is allocated to a target distributed unit (DU) of the mobile IAB mode; and in response to a determination that the particular cell ID is within a reserved list, determining not to trigger the RNAU operation.

In some of the embodiments, the processor is configured to avoid performing the RNAU operation at least by: in response to a determination that the UE is on board with respect to the mobile IAB mode, determining not to trigger the RNAU operation.

In some of the embodiments, the processor is configured to avoid performing the RNAU operation at least by: receiving, from a target DU of the mobile IAB mode, a notification; and in response to receiving the notification, determining not to trigger the RNAU operation.

In some of the embodiments, the processor is configured to avoid performing the RNAU operation at least by: determining the UE is on board with respect to the mobile IAB mode; receiving a RAN area information element in a system information block (SIB) associated with a target DU of the mobile IAB node; in response to a determination that the UE is on board with respect to the mobile IAB mode, updating a stored RNA area configuration of the UE based on the RAN area information element and without the RNAU operation.

According to embodiments disclosed herein, a computer readable medium is disclosed, comprising computer programs that, when executed by one or more processors, cause the one or more processors to perform the steps of any of embodiments above.

According to embodiments disclosed herein, a computer program product is disclosed, comprising computer programs that, when executed by one or more processors, cause the one or more processors to perform the steps of any of embodiments above.

According to embodiments disclosed herein, an apparatus is disclosed, comprising means for performing the steps of any of embodiments above.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A network device, comprising:
at least one antenna;
at least one radio coupled to the at least one antenna; and
a processor coupled to the at least one radio;
wherein the processor is configured to:
perform one or more operations related to an inter-donor full migration associated with a mobile Integrated Access and Backhaul (IAB) node;
wherein the one or more operations comprise one or more of:
determining whether a user equipment (UE) is on board with respect to the mobile IAB node;
avoiding the UE performing cell reselection or cell selection to a source distribute unit (DU) of the mobile IAB node; or
avoiding the UE performing a RAN-based notification area update (RNAU) operation.

2. The network device of claim 1, wherein the processor is configured to determine whether the UE is on board with respect to the mobile IAB node at least by:
receiving, from the UE, a status report associated with an on-board status of the UE.

3. The network device of claim 2, wherein the status report is received in response to at least one of:
a request transmitted from the network device to the UE;
a status change of an on-board status of the UE;
expiration of a configured periodic timer associated with the UE; and/or
a determination that the UE has camped on a cell associated with the mobile IAB node for a configured time period.

4. The network device of claim 1, wherein the processor is configured to determine whether the UE is on board with respect to the mobile IAB node at least by:
receiving a moving speed and orientation of the UE; and
determining, at least based on the received moving speed and orientation of the UE, whether the UE is on board with respect to the mobile IAB node.

5. The network device of claim 4, wherein the moving speed and orientation of the UE is received in response to at least one of:
a request transmitted from the network device to the UE;
expiration of a configured periodic timer associated with the UE; and/or
a determination that the moving speed and orientation of the UE has met one or more configured conditions.

6. The network device of claim 1, wherein the processor is further configured to:
in response to a determination that the UE is on board with respect to the mobile IAB node, configure the UE to perform a conditional handover process or a RACH-less handover process during the inter-donor full migration; and
in response to a determination that the UE is not on board with respect to the mobile IAB node, not configure the UE to perform the conditional handover process or the RACH-less handover process during the inter-donor full migration.

7. The network device of claim 1, wherein the processor is configured to avoid the UE performing cell reselection or cell selection to the source DU at least by one of:
setting a barring bit in a master information block (MIB) associated with the source DU to deny camping UE and coming IDLE UEs or INACTIVE UEs;
setting a reservation bit in a system information block (SIB) associated with the source DU to deny camping UE and coming IDLE UEs or INACTIVE UEs; and/or
decreasing a transmit power associated with the source DU.

8. The network device of claim 1, wherein the processor is configured to avoid the UE performing cell reselection or cell selection to the source DU at least by:
the source DU notifying the UE of execution of the inter-donor full migration through one of paging, short message or group downlink control information (DCI).

9. The network device of claim 1, wherein the processor is configured to avoid the UE performing the RNAU operation at least by:
allocating a particular cell ID to a target DU of the mobile IAB node, wherein the particular cell ID is selected from a reserved list, and wherein each cell ID in the reserved list is preconfigured to not trigger the RNAU operation.

10. The network device of claim 1, wherein the processor is configured to avoid the UE performing the RNAU operation at least by:
configuring a target DU of the mobile IAB node to notify the UE not to trigger the RNAU operation.

11. The network device of claim 10, wherein a source centralized unit (CU) of the mobile IAB node implements the source DU and the target DU during the inter-donor full migration, and wherein the one or more operations comprise at least:
forwarding stored UE context of each UE to the target CU.

12. The network device of claim 1 wherein the processor is configured to avoid the UE performing the RNAU operation at least by:
transmitting a RAN area information element in a system information block (SIB) associated with a target DU of the mobile IAB node, wherein the RAN area information element is used by the UE to update a stored RNA area configuration of the UE without the RNAU operation.

13. The network device of claim 12, wherein the RAN area information element in the SIB is same as RAN area configuration stored by the target DU of the mobile IAB node.

14. A user equipment (UE), comprising:
at least one antenna;
at least one radio coupled to the at least one antenna; and
a processor coupled to the at least one radio;
wherein the processor is configured to:
perform one or more operations related to an inter-donor full migration associated with a mobile Integrated Access and Backhaul (IAB) node;
wherein the one or more operations comprise one or more of:
reporting information to a network device for determining whether the UE is on board with respect to the mobile IAB node;
avoiding performing cell reselection or cell selection to a source distribute unit (DU) of the mobile IAB node; or
avoiding performing a RAN-based notification area update (RNAU) operation.

15. The UE of claim 14, wherein the processor is configured to reporting the information at least by:
transmitting, to the network device, a status report associated with an on-board status of the UE that indicates whether the UE is on-board with respect to the mobile IAB node.

16. The UE of claim 15, wherein the status report is transmitted in response to at least one of:
a request transmitted from the network device to the UE;
a status change of the on-board status of the UE;
expiration of a configured periodic timer associated with the UE; and/or
a determination that the UE has camped on a cell associated with the mobile IAB node for a configured time period.

17. The UE of claim 14, wherein the processor is configured to reporting the information at least by:
transmitting, to the network device, a moving speed and orientation of the UE.

18. The UE of claim 17, wherein the moving speed and orientation of the UE is transmitted in response to at least one of:
a request transmitted from the network device to the UE;
expiration of a configured periodic timer associated with the UE; and/or
a determination that the moving speed and orientation of the UE has met one or more configured conditions.

19. The UE of claim 14, wherein the processor is configured to avoid cell reselection or cell selection to the source DU based on at least one of:
receiving a set barring bit in a master information block (MIB) associated with the source DU;
receiving a set reservation bit in a system information block (SIB) associated with the source DU; and/or
detecting a decreased transmit power associated with the source DU.

20. The UE of claim 14, wherein the processor is configured to avoid cell reselection or cell selection to the source DU at least by:
receiving, from the source DU, a notification of execution of the inter-donor full migration;
upon receiving the notification, performing at least one of:
regarding the source DU as a candidate cell with the lowest priority during cell reselection or cell selection; or
suspending mobility operation until mitigation of a mobile termination (MT) and a DU of the mobile IAB has completed.

21-24. (canceled)
